(19) United States
(12) Patent Application Publication
(10) Pub. No.: US 2007/0272272 A1
(43) Pub. Date: Nov. 29, 2007

(54) Dishwasher and Method Thereof

(75) Inventors: Seung Bong Choi, Gyeongsangnam-do (KR); Byung Hwan Ahn, Gyeongsangnam-do (KR); Hyeokdeok Kim, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/556,826

(22) PCT Filed: Jul. 29, 2005
(86) PCT No.: PCT/KR05/02476

§ 371 Date: Apr. 2, 2007

(30) Foreign Application Priority Data
Jul. 30, 2004 (KR) P 2004-60019
Sep. 9, 2004 (KR) P 2004-72243

(51) Int. Cl. B08B 7/04; B08B 3/00; B08B 9/20

(52) U.S. Cl. 134/18; 134/25.2; 134/34; 134/56 D; 134/57 D

(57) ABSTRACT

Object of the present invention is to provide a dishwasher and a method for controlling operation thereof. The dishwasher includes a body having a washing chamber for washing dishes, at least one rack in the washing chamber for placing dishes thereon, at least one reader unit for sensing information on dishes on the at least one rack, and a control unit for controlling operation of the dishwasher with reference to information on the dishes sensed at the reader unit.

### TECHNICAL FIELD

The present invention relates to dishwashers, and more particularly, to a dishwasher for washing dishes according to information on the dishes which are washing objects, and a method for controlling the same.

### BACKGROUND ART

In general, the dishwasher washes and dries used dishes, automatically.

FIG. 1, attached hereto, illustrates an inside structure of the foregoing related art dishwasher, schematically.

The related art dishwasher is provided with a body 10, a sump 20, a washing pump 30, spray arms 41, and 42, racks 51, and 52 for placing the dishes thereon, and a drain pump 60.

Inside of the body 10, there is a washing chamber 11 for washing the dish 1.

The sump 20 holds washing water supplied from an outside of the dishwasher, and provides the washing water to the washing pump 30. The sump 20 has a drain hose 61 connected thereto for draining contaminated washing water.

The washing pump 30 pumps up washing water from the sump 20, and sprays the washing water to the dishes 1 through the spray arms 41, and 42.

The spray arms 41, and 42 are an upper spray arm 41 mounted on an upper side of the washing chamber 11, and a lower spray arm 42 mounted on a lower side of the washing chamber 11.

The spray arms 41, and 42 wash the dishes 1 by spraying the washing water pumped up by the washing pump 30.

Particularly, the spray arms 41, and 42 are rotatably mounted, and each has a plurality of nozzles (not shown) on a surface thereof. The spray arms 41, and 42 are rotated by spraying force of the washing water from the nozzles, or a separate driving motor.

The spray arms 41, and 42 and the washing pump 30 are connected to each other with washing water guides 71, and 72, respectively. In more detail, the washing water guides 71, and 72 are an upper connection pipe 71 for providing the washing water from the washing pump 30 to the upper spray arm 41, and a lower connection pipe 72 for providing the washing water from the washing pump 30 to the lower spray arm 42.

The racks 51, and 52 hold various kinds of dishes 1, which are washing objects. The racks 51, and 52 are an upper rack 51 in an upper space of the washing chamber 11, and a lower rack 52 in a lower space of the washing chamber 11.

The drain pump 60 is mounted in a pipeline of the drain hose 61 connected to the sump 20 for draining contaminated washing water to an outside of the dishwasher.

Therefore, when the dishwasher is put into operation in a state the dishes 1 are placed on the racks 51, and 52, the washing water is supplied to the sump 20.

Then, the washing pump 30 is operated, to supply the washing water from the sump 20 to the spray arms 41, and 42 through the upper connection pipe 71 and the lower connection pipe 72, respectively.

The washing water, respectively guided to the spray arms 41, and 42, is sprayed toward the dishes 1 on the racks 51, and 52, to wash the dishes.

However, the related art dishwasher has a problem in that there has been excessive waste of washing water in a case a number of the dishes are small, and there has been shortage of washing water to fail in smooth washing of the dishes in a case a number of the dishes are great, because the related art dishwasher is always operative in the same operation condition regardless of a number of the dishes placed thereon, or positions of the dishes in the dishwasher.

Moreover, the related art dishwasher also has a problem in that dish washing efficiency is poor and there is excessive waste of washing water, because the washing water is sprayed through both of the upper spray arm 41 and the lower spray arm 42 even if the dishes are placed only one of the racks 51, and 52.

Furthermore, the related art dishwasher also has a problem in that dish washing proper to kinds of dishes, or degree of contamination is failed, because the related art dishwasher is always operative in the same operation condition regardless of kinds of the dishes.

[Disclosure]

[Technical Problem]

An object of the present invention is to provide a dishwasher which can perform dish washing effectively, and a controlling method for operating the same.

[Technical Solution]

The object of the present invention can be achieved by providing a dishwasher including a body having a washing chamber for washing dishes, at least one rack in the washing chamber for placing dishes thereon, at least one reader unit for sensing information on dishes on the at least one rack, and a control unit for controlling operation of the dishwasher with reference to information on the dishes sensed at the reader unit.

The reader unit senses information on the dishes from information tags attached to the dishes on the at least one rack, respectively.

The information tag includes a RFID tag, and the reader unit includes a RF reader.

Preferably, the information tag has at least one kind of information on a kind of the dish, a main use of the dish, a use of the dish served, and a shape of the dish.

The at least one reader unit is provided to the at least one rack, for sensing information on the dishes respectively placed on the racks.

The at least one reader unit is provided to a path for introduction of the dishes to the body.

In another aspect of the present invention, a method for controlling a dishwasher includes a first step of determining positions of dishes on a plurality of racks in a washing chamber, a second step for setting a spray condition of washing water according to a distribution of the dishes, and a third step of operating the dishwasher according to the set spray condition.

The second step includes the step of setting a spray condition of washing water such that more washing water is sprayed to a rack having more dishes placed thereon with reference to amounts of dishes on the plurality of racks.

The second step includes the step of setting a spray condition of washing water such that washing water is sprayed to the racks in proportion to amounts of dishes respectively placed thereon with reference to amounts of dishes on the plurality of racks, respectively.

The first step further includes the steps of sensing kinds and positions of dishes on at least one rack, comparing the kinds and positions of the dishes sensed thus to preset information on positions of dishes suitable to kinds of dishes, and informing a positioning error of the dish if the dish is positioned improperly.

In another aspect of the present invention, a method for controlling operation a dishwasher includes a first step of sensing information on dishes on at least one rack, a second step of setting an operation condition according to the information on the dishes sensed thus, and a third step of performing washing of the dishes according to the operation condition set thus.

The first step includes the step of sensing at least one kind of information on kinds of the dishes, main use of the dishes, use of the dishes served, shapes of the dishes, and positions of the dishes placed.

The second step includes the step of setting at least one of operation conditions of whether a soaking cycle is to be performed or not, a washing time period, whether washing water is used again, or not.

The second step includes the step of setting to perform a soaking cycle before a dish washing cycle is performed, if the dish on the rack is a dish for putting food which is liable to stick.

The second step includes the step of setting a long washing time period, if the dish on the rack is a dish of which main use or use served is for putting food which is liable to stick, and setting a short washing time period, if the dish on the rack is a dish of which main use or use served is for putting food which is not liable to stick.

The second step includes the step of setting such that the washing water is not re-used, if the dish on the rack is a dish of which main use is for putting food which is liable to contaminate the washing water.

In another aspect of the present invention, a method for controlling operation of a dishwasher includes a first step of sensing information on dishes placed on a rack, a second step of determining a kind of detergent with reference to the information on dishes sensed thus, and a third step for expressing the kind of detergent determined thus to a user.

The third step includes the step of displaying the kind of detergent on a screen of a display.

The third step includes the step of presenting the kind of detergent with a voice through a speaker.

[Advantageous Effects]

The dishwasher and method for controlling operation thereof permit to wash dishes introduced to the washing chamber in an optimum state, and to reduce consumption of washing water.

### DESCRIPTION OF DRAWINGS

The accompanying drawings, which are included to provide a further understanding of the invention, illustrate embodiment(s) of the invention and together with the description serve to explain the principle of the invention. In the drawings;

FIG. 1 illustrates a front section showing an inside structure of a related art dishwasher, schematically;

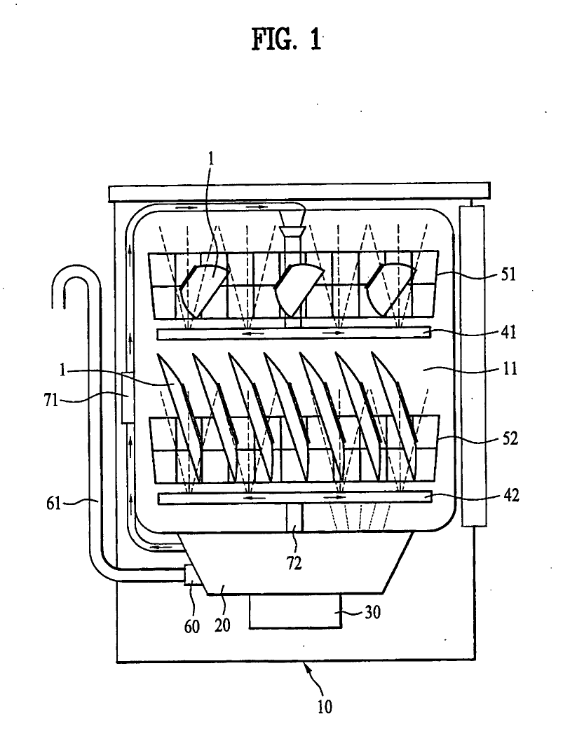

FIG. 2 illustrates a front section showing an inside structure of a dishwasher in accordance with a preferred embodiment of the present invention, schematically;

FIG. 3 illustrates a flow chart showing the steps of a controlling method for operating a dishwashing in accordance with a first preferred embodiment of the present invention;

FIG. 4 illustrates a flow chart showing the steps of a controlling method for operating a dishwashing in accordance with a first preferred embodiment of the present invention;

FIG. 5 illustrates a flow chart showing the steps of a controlling method for operating a dishwashing in accordance with a first preferred embodiment of the present invention;

FIG. 6 illustrates a flow chart showing the steps of a controlling method for operating a dishwashing in accordance with a first preferred embodiment of the present invention;

FIG. 7 illustrates a flow chart showing the steps of a controlling method for operating a dishwashing in accordance with a first preferred embodiment of the present invention;

### BEST MODE

Reference will now be made in detail to the preferred embodiments of the present invention, examples of which are illustrated in the accompanying drawings. Wherever possible, the same reference numbers will be used throughout the drawings to refer to the same or like parts.

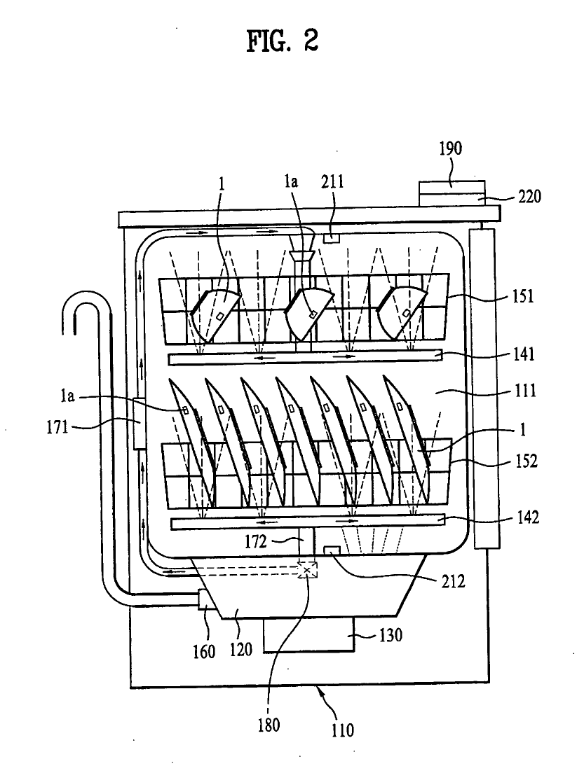

Referring to FIG. 2, the dishwasher includes a body 110, a sump 120, a washing pump 130, at least one rack 151, and 152 for placing the dishes thereon, spray arms 141, and 142, a flow control valve 180, at least one reader unit 211, and 212, and a control unit 220.

Inside of the body 110, there is a washing chamber 111 for washing the dishes 1.

The sump 120 holds washing water, and provides the washing water to the washing pump 130.

The washing pump 130, composing a water holding unit together with the sump 120, pumps up washing water from the sump 120 to the spray arms 41, and 42 which will be described later.

The racks 151, and 152, designed to receive the dishes 1, are an upper rack 151 in an upper space of the washing chamber 111, and a lower rack 152 in a lower space of the washing chamber 111.

The spray arms 141, and 142 are an upper spray arm 141 mounted on an upper side of the washing chamber 111, and a lower spray arm 142 mounted on a lower side of the washing chamber 111.

The spray arms 141, and 142 wash the dishes 1 by spraying the washing water pumped up by the washing pump 130 to the upper, and lower spaces of the washing chamber 111.

The spray arms 141, and 142 are connected to the washing pump 130 are connected with connection pipes 171, and 172 respectively for supplying washing water.

The connection pipes 171, and 172 are an upper connection pipe 171 for supplying the washing water from the washing pump 30 to the upper spray arm 141, and a lower connection pipe 172 for supplying the washing water from the washing pump 130 to the lower spray arm 142.

Though the flow control valve 180 can be mounted both in the upper connection pipe 171 and the lower connection pipe 172, mounting the flow control valve 180 at an intersection of the connection pipes 171, and 172 is favorable for reducing a production cost.

The reader units 211, and 212 sense at least one kind of information on positions of dishes, kinds of dishes, shapes of dishes, use of dishes on the upper rack 151 and the lower rack 172.

In this instance, each of the dishes 1 has an information tag 1a having various kinds of information on the dish stored therein attached thereto, and each of the reader units 211, and 212 exchanges a signal with the information tag 1a on the dish 1, to determine a kind of the dish.

Particularly, it is preferable that the information tag 1a is a RFID Tag (Radio Frequency Identification Tag), and the reader units 211, and 212 are RF readers. The information tag 200 is the RFID Tag on which information may be written, additionally.

Of course, though not shown, it is more preferable that the reader units 211, and 212 are enclosed with a separate case or sealing member for preventing water infiltration thereto.

Though the information tag 200 can be attached to the dish 1 during a fabrication process of the dish 1, the information tag 200 can be attached to the dish 1 by the user.

It is more preferable that the information tag 200 further has at least one kind of information on preferable washing conditions of the dish 1, i.e., a washing time period, a washing temperature, a pressure of washing water, an amount of washing water, a recommendable kind of detergent stored therein.

Of course, the information tag 200 may be a bar code, and the reader unit 211, and 212 may be a bar code reader, or one of other various structures which enables information exchange by other noncontact methods.

Moreover, it is preferable that the information tag 1a on the dish 1 has one kind of information selected from a kind of the dish, use of the dish, main use of the dish, a shape of the dish, and so on.

Moreover, it is preferable that the reader units 211, and 212 are provided to the upper rack 151, and the lower rack 152 respectively for identifying a position of the dish 1 on the rack 151, and 152.

That is, the reader unit 211 mounted to the upper rack 151 is configured only to determine the information tag 1a on the dish 1 on the upper rack 151, and the reader unit 212 mounted to the lower rack 152 is configured only to determine the information tag 1a on the dish 1 on the lower rack 152.

Of course, of various portions of the body 110, the reader units 211, and 212 may be mounted in a path through which the dish is introduced to the washing chamber 111, and may be provided three of more than three sets.

The control unit 220 controls various units of the dishwasher.

Particularly, the control unit 220 receives information from the reader unit 211, or 212, and determines if the dishes 1 are appropriately placed or not, for performing an optimum dish washing.

Along with this, the control unit 220 controls such that the dishes 1 have different spray rates of washing water depending on concentration of the dishes 1.

In this instance, the control unit 220 controls the washing by setting operation of various unit of the dishwasher, including the washing pump 130, and the flow control valve 180.

It is preferable that the dishwasher further includes a noticing unit 190 for giving a notice on various kinds of information to the user.

The noticing unit 190 includes at least one of a display screen for displaying information thereon, such as an LCD window, or a speaker for presenting a vocal sound.

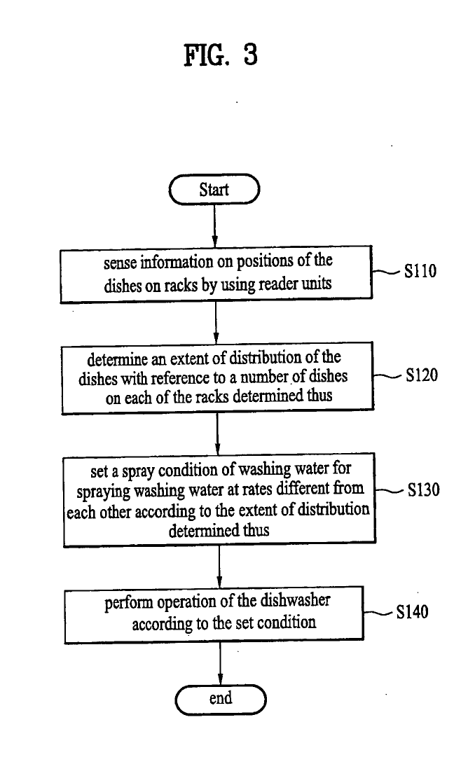

A controlling method for operating the foregoing dishwasher in accordance with a first preferred embodiment of the present invention will be described in more detail with reference to the flow chart in FIG. 3 according to an operation flow of the dishwasher.

When a plurality of dishes 1 intended to wash are introduced to the washing chamber 111, the reader unit 210 senses information on positions of the dishes 1 on at least one rack 151, and 152 (S110).

The sensing for each of the dishes 1 is made by at least one reader unit 211, and 212 on at least one rack 151, and 152.

As there are the upper rack 151 and the lower rack 152 in the washing chamber, the reader unit 211 at the upper rack 151 senses a number of dishes 1 on the upper rack 151, and the reader unit 212 at the lower rack 152 senses a number of dishes 1 on the lower rack 152, thus the dishwasher determines positions of entire dishes in the washing chamber 11.

Then, the control unit 220 determines an extent of distribution of the dishes 1 with reference to a number of dishes 1 on each of the racks 151, and 152 determined by the reader units 151, and 152 (S120), and sets a spray condition of washing water for spraying washing water at rates different from each other according to the extent of distribution determined thus (S130).

For an example, with reference to numbers of dishes on the racks 151, and 152 respectively, the spray condition is set such that more washing water is sprayed to a rack having more dishes placed thereon.

That is, the control unit 220 determines numbers of dishes on the upper rack 151, and the lower rack 152, and sets the spray condition such that more washing water is sprayed to a rack having more dishes placed thereon.

The setting of spray rate of the washing water is a setting for controlling an extent of opening of the flow control valve 180.

Particularly, it is preferable that the spray rates of the washing water to the racks are set proportional to amounts of dishes on the racks 151, and 152, respectively.

For an example, if a number of dishes 1 on the upper rack 151 are 7, and a number of dishes 1 on the lower rack 152 are 3, an algorithm for controlling the flow control valve 180 is set such that 70% of total washing water flows to the upper spray arm 141 which sprays washing water to the upper rack 151, and 30% of total washing water flows to the lower spray arm 142 which sprays washing water to the lower rack 152.

Upon setting the spray condition of the washing water according to information on dishes, the control unit 220 performs operation of the dishwasher according to the set condition (S140).

In the meantime, in general, the dishwasher has preferable positions of dishes for the racks 151, and 152, or portions of the racks 151, and 152.

That is, it is the most preferable that a kind of dish is placed on a portion where the best effective washing can be made according to flow of washing water.

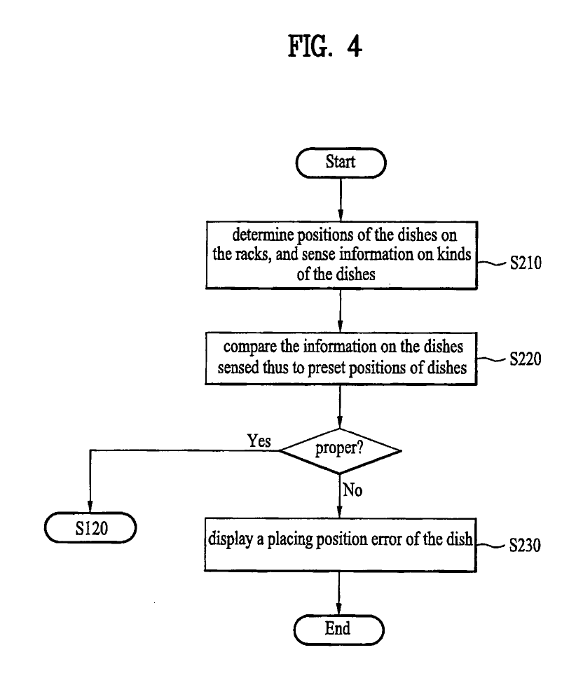

Accordingly, the embodiment of the present invention suggests a series of control steps for inducing placing of the most preferable kind of dish on every rack (or portions of the racks) additionally, which will be described with reference to the flow chart in FIG. 4.

The reader unit 211, or 212 exchanges information with the information tag 1a on the dish 1 on the rack 151, or 152 in the washing chamber 111 like the series of steps described before, i.e., S110, to sense positions of the dishes, in which step the reader units sense information on kinds of the dishes 1 from the information tag 1a, additionally (S210).

The information is provided from the reader units 211, and 212 to the control unit 220, and the control unit 220 compares the information on kinds and positions of the dishes 1 to preset positions of dishes, to determine whether the dishes are placed properly or not (S220).

If a particular dish 1 is placed on a position, not proper, but improper, the control unit 220 informs a placing position error of the dish to the user through the noticing unit 190 (S230), so that the user can change the position to the most preferable state.

For an example, if a bowl is placed on a position for a dish, the placing error of the bowl is informed to the user, for guiding the user to place the bowl at a position for a bowl.

If the positions of the dishes 1 are corrected exactly, the control unit 220 performs washing of the dishes by the foregoing embodiment, i.e., the series of steps like S120 to S140 by controlling the washing pump 130, the flow control valve 180, and so on.

In the meantime, the reader units 211, and 212 may be provided in a path of the body 110 for introduction of the dishes.

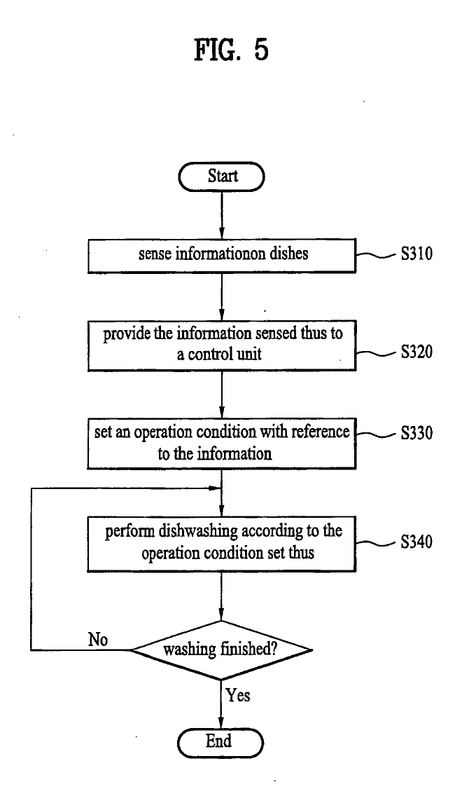

A controlling method for operating the foregoing dishwasher in accordance with a third preferred embodiment of the present invention will be described in more detail with reference to FIG. 5.

If a plurality of dishes 1 intended to wash is introduced to the washing chamber 111, the reader units 211, and 212 obtain various kinds of information on the dishes 1 from the information tags 1a on the dishes 1 introduced thus under the control of the control unit 220 (S310).

The information on the dish 1 the reader 211, or 212 senses includes at least one kind of information on a shape of the dish 1, main use of the dish 1, use of the dish 1 served, a shape of the dish 1.

Upon finishing sensing of the information, the control unit 220 receives the information from the reader units 211, and 212 (S320), and sets a washing operation condition with reference to the information received thus (S330).

In this instance, the setting of washing operation is made by setting operation of various units (for example, a centrifugal pump, a drain pump, a driving motor, and so, on) required for controlling a pressure of washing water, a total washing time period, and so on, and setting whether the washing water is used or not again.

With regard to the setting whether the washing water is used or not again, if it is determined that the use of the dish 1 is for putting food which is liable to contaminate the dish l (for an example, the dish is a cooking container, or a dish for putting greasy food therein) therein, an operation time of the drain pump is set to be controlled such that the washing water used once is not used again.

Of course, it is more preferable that an amount of detergent for the washing, and so on are also set in the foregoing step of setting the washing operation.

Upon finishing setting of the washing operation by above series of steps, the control unit 220 controls such that washing of the dishes 1 in the washing chamber 111 is performed by controlling various units of the dishwasher (S340).

In the meantime, it is preferable that setting whether a soaking cycle is performed before the washing cycle is performed or not can be further performed in the foregoing series of operation control steps in accordance with the third preferred embodiment of the present invention.

This is because soaking the dish 1 before washing the dish 1 is liable to enhance a washing effect of the dish in a case of a dish 1 for putting food which is liable to stick, such as a steamed rice bowl therein.

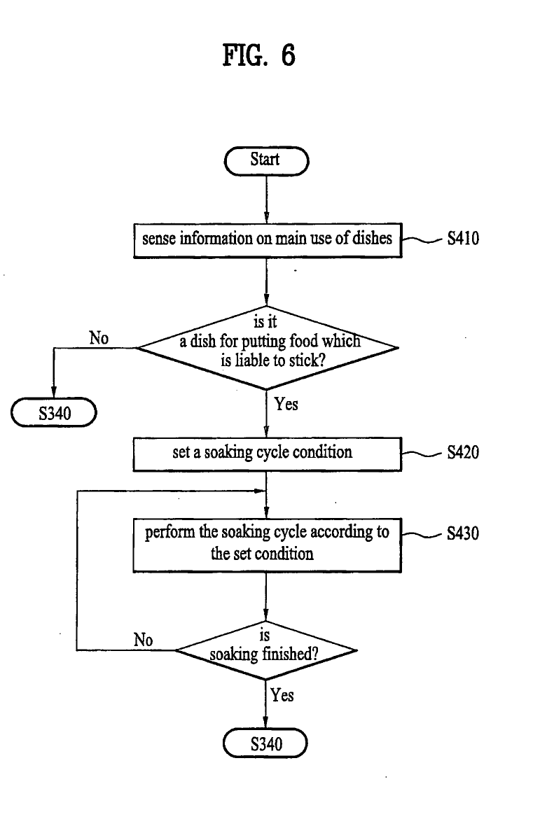

Accordingly, a fourth preferred embodiment of the present invention suggests performing the soaking cycle of a series of steps like a flow chart in FIG. 6 attached hereto.

If the main use of the dish 1 sensed at the reader 220 is a dish for putting food which is liable to stick therein (S410), a setting is made such that the soaking cycle is performed for a predetermined time period after washing water is only sprayed before performing the washing cycle (S420).

It is preferable that no detergent is used in the middle of the soaking cycle.

Then, the control unit 220 performs the soaking cycle according to the setting by controlling the various units (S430), and then, the washing cycle is performed (S340).

If it is determined that the dish 1 is for putting food which is not liable to stick, a setting is made such that the washing cycle is performed without the soaking cycle.

In the meantime, by nature of the dishwasher, operation control of various units thereof can be performed automatically.

However, it is difficult to make automatic change of kinds of detergent suitable to main use of the dishes 1.

Of course, if detergent boxes (not shown) for putting various kinds of detergent therein separately is provided, the automatic change of detergent is possible.

However, taking that a single detergent box is provided to a general dishwasher into account, selection and introduction of the detergent is made by the user.

Consequently, the related art dishwasher has a poor washing efficiency actually because only the same kind of detergent is used regardless of kinds of dishes.

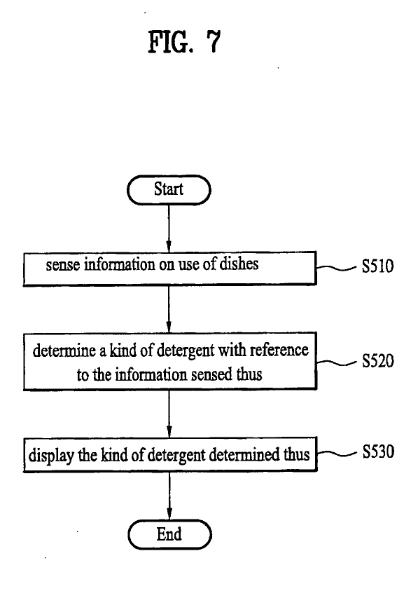

Next, a control method for operating a dishwasher in accordance with a fifth preferred embodiment of the present invention will be described with reference to FIG. 7.

Information on use of dishes 1 is sensed from information tags 1a on a plurality of dishes 1 introduced to a washing chamber by using a reader unit 220 (S510), and the most preferable kind of detergent is determined for a washing cycle (S520).

Then, the kind of detergent determined thus is expressed, to give notice to the user (S530).

The kind of detergent is a kind of detergent for general dish washing, a kind of detergent for removal of greasy component, a kind of detergent for sterilizing or disinfection.

In the method for giving notice to the user of the kind of detergent to be used, the kind of detergent may be displayed on a display of the noticing unit 190, or a vocal sound may be provided through a speaker.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

[Industrial Applicability]

The dishwasher and an operating method thereof have the following advantages.

A washing cycle can be performed in an optimum washing condition by determining information on washing of dishes by a contact method.

As more washing water can be sprayed to a rack having more dishes thereon, to improve washing efficiency, and as less washing water can be spray to a rack having less dishes, to prevent waste of washing water.

The correction of wrong placing of dishes, and the determination of a proper detergent, and soaking cycle permits an efficient dishwashing.

1. A dishwasher comprising:
a body having a washing chamber for washing dishes;
at least one rack in the washing chamber for placing dishes thereon;
at least one reader unit for sensing information on dishes on the at least one rack; and
a control unit for controlling operation of the dishwasher with reference to information on the dishes sensed at the reader unit.

2. The dishwasher as claimed in claim 1, wherein the reader unit senses information on the dishes from information tags attached to the dishes on the at least one rack, respectively.

3. The dishwasher as claimed in claim 2, wherein the information tag includes a RFID (Radio Frequency Identification) tag, and the reader unit includes a RF (Radio Frequency) reader.

4. The dishwasher as claimed in claim 2, wherein the information tag has at least one kind of information on a kind of the dish, a main use of the dish, a use of the dish served, and a shape of the dish.

5. The dishwasher as claimed in claim 1, wherein the at least one reader unit is provided to the at least one rack, for sensing information on the dishes respectively placed on the racks.

6. The dishwasher as claimed in claim 1, wherein the at least one reader unit is provided to a path for introduction of the dishes to the body.

7. A method for controlling a dishwasher comprising:
a first step of determining positions of dishes on a plurality of racks in a washing chamber;
a second step for setting a spray condition of washing water according to a distribution of the dishes; and
a third step of operating the dishwasher according to the set spray condition.

8. The method as claimed in claim 7, wherein the second step includes the step of setting a spray condition of washing water such that more washing water is sprayed to a rack having more dishes placed thereon with reference to amounts of dishes on the plurality of racks.

9. The method as claimed in claim 7, wherein the second step includes the step of setting a spray condition of washing water such that washing water is sprayed to the racks in proportion to amounts of dishes respectively placed thereon with reference to amounts of dishes on the plurality of racks, respectively.

10. The method as claimed in claim 7, wherein the first step further includes the steps of;
sensing kinds and positions of dishes on at least one rack,
comparing the kinds and positions of the dishes sensed thus to preset information on positions of dishes suitable to kinds of dishes, and
informing a positioning error of the dish if the dish is positioned improperly.

11. A method for controlling operation a dishwasher comprising:
a first step of sensing information on dishes on at least one rack;
a second step of setting an operation condition according to the information on the dishes sensed thus; and
a third step of performing washing of the dishes according to the operation condition set thus.

12. The method as claimed in claim 11, wherein the first step includes the step of sensing at least one kind of information on kinds of the dishes, main use of the dishes, use of the dishes served, shapes of the dishes, and positions of the dishes placed.

13. The method as claimed in claim 11, wherein the second step includes the step of setting at least one of operation conditions of whether a soaking cycle is to be performed or not, a washing time period, whether washing water is used again, or not.

14. The method as claimed in claim 11, wherein the second step includes the step of setting to perform a soaking cycle before a dish washing cycle is performed, if the dish on the rack is a dish for putting food which is liable to stick.

15. The method as claimed in claim 11, wherein the second step includes the step of setting a long washing time period, if the dish on the rack is a dish of which main use or use served is for putting food which is liable to stick, and setting a short washing time period, if the dish on the rack is a dish of which main use or use served is for putting food which is not liable to stick.

16. The method as claimed in claim 11, wherein the second step includes the step of setting such that the washing water is not re-used, if the dish on the rack is a dish of which main use is for putting food which is liable to contaminate the washing water.

17. A method for controlling operation of a dishwasher comprising:
a first step of sensing information on dishes placed on a rack;
a second step of determining a kind of detergent with reference to the information on dishes sensed thus; and
a third step for expressing the kind of detergent determined thus to a user.

18. The method as claimed in claim 17, wherein the third step includes the step of displaying the kind of detergent on a screen of a display.

19. The method as claimed in claim 17, wherein the third step includes the step of presenting the kind of detergent with a voice through a speaker.
